(19) United States
(12) Patent Application Publication
(10) Pub. No.: US 2025/0046918 A1
(43) Pub. Date: Feb. 6, 2025

(54) BATTERY AND METHOD FOR PREPARING THE SAME

(71) Applicant: ZHUHAI COSMX BATTERY CO., LTD., Zhuhai (CN)

(72) Inventors: Fangbo CAO, Zhuhai (CN); Hanli SUN, Zhuhai (CN); Yu XIANG, Zhuhai (CN); Donghui SHENG, Zhuhai (CN); Jichun XIE, Zhuhai (CN)

(73) Assignee: ZHUHAI COSMX BATTERY CO., LTD., Zhuhai (CN)

(21) Appl. No.: 18/924,958

(22) Filed: Oct. 23, 2024

Related U.S. Application Data
(63) Continuation of application No. PCT/CN2023/116198, filed on Aug. 31, 2023.

(30) Foreign Application Priority Data
Dec. 15, 2022 (CN) 202211615839.7

(51) Int. Cl. H01M 50/105; B29C 65/00; B29C 65/14; B29K 23/00; B29L 31/00; H01M 50/119; H01M 50/121; H01M 50/129; H01M 50/131

(52) U.S. Cl. CPC H01M 50/105; B29C 65/14; B29C 66/341; B29C 66/433; B29C 66/72321; B29C 66/73776; H01M 50/119; H01M 50/121; H01M 50/129; H01M 50/131; B29K 2023/00; B29K 2995/0012; B29K 2995/0041; B29K 2995/0069; B29L 2031/7146

(57) ABSTRACT

A battery includes a battery cell and a packaging body, an edge of at least one side of the packaging body is provided with a sealing region to seal and wrap the battery cell body in the packaging body, and the packaging body includes a heat sealing layer; and in the sealing region, a side, away from the battery cell body, of the heat sealing layer is an outer sealing side, a side, close to the battery cell body, of the heat sealing layer is an inner sealing side, and a crystallinity of the outer sealing side is greater than a crystallinity of the inner sealing side. The battery includes the packaging body with a high packaging strength and a strong resistance to bending, which may more effectively block water vapor from entering a battery, and also improves safety performance and a service life of a battery.

### CROSS-REFERENCE TO RELATED APPLICATIONS

This application is a continuation of International Application No. PCT/CN2023/116198, filed on Aug. 31, 2023, which claims priority to Chinese Patent Application No. 202211615839.7, filed on Dec. 15, 2022. The disclosures of the aforementioned applications are hereby incorporated by reference in their entireties.

### TECHNICAL FIELD

The present disclosure relates to the field of battery technologies, and in particular, to a battery and a method for preparing the same.

### BACKGROUND

A packaging of an aluminum laminated film of a pouch lithium-ion battery is mainly to wrap a bare battery cell by the aluminum laminated film. Nowadays, as a pouch battery cell enters the field of a power battery cell, requirements for the packaging of the aluminum laminated film are further increased, for example, the power battery cell requires a packaging region of the aluminum laminated film with a relatively high packaging strength and a resistance to bending. Therefore, it is of great significance to develop a battery with an aluminum laminated film that has a high packaging strength and a strong resistance to bending.

SUMMARY

The purposes of the present disclosure are to overcome problems mentioned above in the related technologies, and therefore, a battery and a method for preparing the same are provided. The battery includes a packaging body (for example, an aluminum laminated composite film) with a high packaging strength and a strong resistance to bending, which may more effectively block water vapor from entering a battery, and also improves safety performance and a service life of a battery.

In order to achieve the purposes mentioned above, a first aspect of the present disclosure provides a battery, including a battery cell body and a packaging body, an edge of at least one side of the packaging body is provided with a sealing region to seal and wrap the battery cell body in the packaging body, and the packaging body includes a heat sealing layer; and in the sealing region, a side, away from the battery cell body, of the heat sealing layer is an outer sealing side, a side, close to the battery cell body, of the heat sealing layer is an inner sealing side, and a crystallinity of the outer sealing side is greater than a crystallinity of the inner sealing side.

A second aspect of the present disclosure provides a method for preparing the battery according to the first aspect of the present disclosure, including: S310: providing an electromagnetic induction heating apparatus at an edge of a to-be-sealed region on at least one side of a packaging body of the battery; S320: heating the to-be-sealed region by using the electromagnetic induction heating apparatus to fuse a heat sealing layer of the packaging body; and S330: after the electromagnetic induction heating apparatus stops heating, recrystallizing the heat sealing layer to form a sealing region on the at least one side of the packaging body, where a side, away from a battery cell body of the battery, of the heat sealing layer is an outer sealing side, a side, close to the battery cell body, of the heat sealing layer is an inner sealing side, the packaging body is used for packaging the battery cell body, a temperature of the heat sealing layer has a decreasing trend along a direction from the outer sealing side to the inner sealing side, and a crystallinity of the outer sealing side is greater than a crystallinity of the inner sealing side.

The present disclosure has the following beneficial effects by adopting the above technical solutions: the to-be-sealed region is heated by using the electromagnetic induction heating apparatus, so that the temperature of the heat sealing layer has a decreasing trend along the direction from the outer sealing side to the inner sealing side, thereby making a crystallinity of the heat sealing layer also have a decreasing trend. The inner sealing side close to the battery cell has a low crystallinity and a good elasticity, so as to ensure that the inner sealing side is less prone to fracture during edge folding; and the outer sealing side away from the battery cell has a high crystallinity, a relatively high strength and a relatively high resistance to stretching, thereby improving a sealing strength, and thus effectively blocking water vapor. That is to say, the battery of the present disclosure includes the packaging body with a high packaging strength and a strong resistance to bending, which may more effectively block water vapor from entering a battery, and also improves safety performance and a service life of a battery.

### BRIEF DESCRIPTION OF THE DRAWINGS

FIG. 1 is a schematic structural diagram of a cross section of a battery according to an example of the present disclosure.

FIG. 2 is a schematic diagram of a heat sealing layer made of polypropylene according to an example of the present disclosure.

FIG. 3a is a schematic structural diagram of a cross section of an aluminum laminated composite film according to an example of the present disclosure.

FIG. 3b is a schematic flowchart of a method for preparing a battery according to an example of the present disclosure.

FIG. 4 is a schematic diagram of aluminum laminated composite film heated by a non-contact heat source according to an example of the present disclosure.

FIG. 5 is a schematic structural diagram of a cross section of a battery cell according to an example of the present disclosure.

### DETAILED DESCRIPTION OF THE EMBODIMENTS

Specific implementations of the present disclosure are described in detail below. It should be understood that the specific implementations described herein are only used to illustrate and explain the present disclosure, and are not intended to limit the present disclosure.

Unless otherwise defined, all scientific and technical terms used in the present disclosure have the same meaning as commonly understood by those skilled in the art to which the present disclosure relates.

An aluminum laminated film of a pouch battery is a composite film including an outer protective layer, an intermediate metal layer and an inner heat sealing layer which are bonded by using an adhesive. A packaging of the aluminum laminated film of a pouch lithium-ion battery is mainly that after a bare battery cell is wrapped by the aluminum laminated film, a heat sealing layer in a packaging region is fused under a high temperature and a high pressure from a sealing head, thereby forming a closed space. The aluminum laminated film, serving as a shell material of the pouch battery, has a role in isolating air and moisture and protecting a battery cell. At present, the heat sealing layer in the packaging region is fused under the high temperature and the high pressure from the sealing head, which makes the overall heat sealing layer have a relatively high crystallinity, and leads to problems such as liquid leakage due to a poor resistance to bending, a high hardness, and susceptibility to breakage.

A first aspect of the present disclosure provides a battery, including a battery cell and a packaging body, an edge of at least one side of the packaging body is provided with a sealing region to seal and wrap the battery cell body in the packaging body, and the packaging body includes a protective layer, a metal layer, and a heat sealing layer that are stacked in sequence. In the sealing region, a side, away from the battery cell body, of the heat sealing layer is an outer sealing side, a side, close to the battery cell body, of the heat sealing layer is an inner sealing side, and a crystallinity of the outer sealing side is greater than a crystallinity of the inner sealing side.

In the present disclosure, the battery cell body and a battery cell have the same meaning.

In one example, the packaging body is an aluminum laminated composite film. The following explanation takes the packaging body being an aluminum laminated composite film as an example.

In the present disclosure, the inner sealing side close to the battery cell has a low crystallinity and a good elasticity, so as to ensure that the inner sealing side is less prone to fracture during edge folding; and the outer sealing side away from the battery cell has a high crystallinity, a relatively high strength and a relatively high resistance to stretching, thereby improving a sealing strength, and thus effectively blocking water vapor.

In one example, the sealing region is divided along a center line of its lengthwise direction, a region from the center line towards a side close to the battery cell is an inner sealing region, and a region from the center line towards a side away from the cell is an outer sealing region.

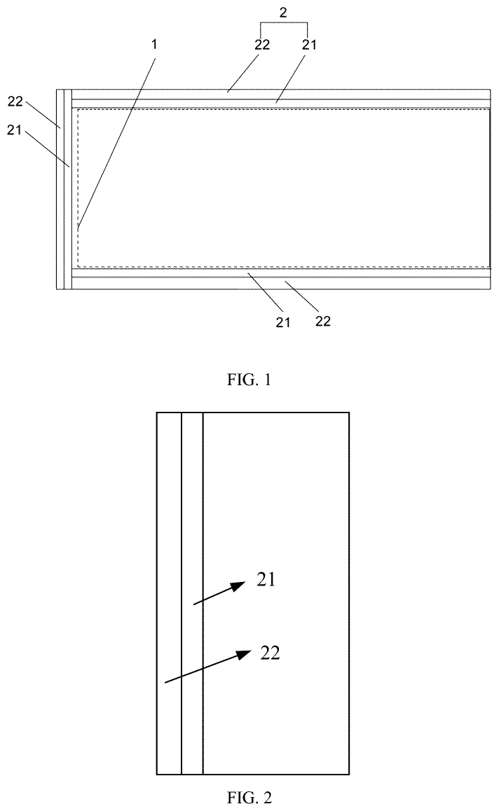

In one example, as shown in FIG. 1, the battery includes the battery cell 1 and the packaging body for sealing and wrapping the battery cell, the sealing region 2 in the packaging body is divided into the inner sealing region 21 and the outer sealing region 22 along the center line of its lengthwise direction, and a crystallinity of the heat sealing layer has a decreasing trend along a direction from the outer sealing region 22 to the inner sealing region 21.

In one example, the battery cell is a pouch battery cell, the battery cell includes a positive electrode plate, a separator, a negative electrode plate, and an electrolyte, a selection of the positive electrode plate, the separator, the negative electrode plate, and the electrolyte is not specifically limited, and may be determined according to requirements in this field, and an assembly of the battery cell is performed in a conventional manner in this field.

In one example, the packaging body includes the protective layer, the metal layer, and the heat sealing layer that are stacked in sequence along a direction close to the battery cell.

Exemplarily, the protective layer is selected from at least one of nylon, polyethylene terephthalate, polybutylene terephthalate, polyvinylidene fluoride, polytetrafluoroethylene, polypropylene, polyamide, and polyimide.

Exemplarily, the metal layer includes at least one of aluminum foil, aluminum alloy foil, copper foil, copper alloy foil, iron foil, iron alloy foil, nickel foil, and nickel alloy foil.

In order to better enable the packaging body to have a relatively high packaging strength and a relatively strong resistance to bending, one or more of the technical features may be further preferred.

In one example, the crystallinity of the heat sealing layer has a decreasing trend along the direction from the outer sealing side to the inner sealing side.

The crystallinity (Xe) represents a mass fraction or a volume fraction of a crystalline region in high polymer, which is one of important parameters characterizing semi-crystalline polymer and has a direct relationship with many important properties of the polymer. Generally, the greater the crystallinity, the greater a density, a strength, a hardness, and a stiffness of a material, as well as its dimensional stability, heat resistance and chemical resistance, but its elasticity, elongation at break, impact strength, light transmittance and the like are reduced.

In one example, a method of differential scanning calorimetry (DSC) is used to test the crystallinity, expressed as a mass fraction, of both the inner sealing side and the outer sealing side, a test principle is as follows: an amount of heat (a melting enthalpy ΔH_{actual} of a sample) absorbed by polymorphs of a same type of polymer during its melting process is directly proportional to its crystallinity, and a test process is represented by the following formula: Xe=ΔH_{actual}/ΔH_{(crystallinity of 100%)}, where the Xe is the crystallinity, the ΔH_{actual} is an actual melting enthalpy of a sample, and the ΔH_{(crystallinity of 100%)} is a melting enthalpy at a crystallinity of 100%.

In one example, a difference in crystallinity between the outer sealing side and the inner sealing side, calculated based on a mass fraction, ranges from 0.5% to 50%, preferably from 1% to 20%.

In one example, a test method of X-ray diffraction (XRD) is adopted to test the crystallinity, expressed as a volume fraction, of both the inner sealing side and the outer sealing side, and a test principle is as follows: a sample is composed of two distinctly different phases, since an electron density of a crystallization region is greater than an electron density of a non-crystallization region, a diffraction peak of the crystallization region and a dispersion peak of the non-crystallization region are correspondingly generated, and a proportion of an intensity of the diffraction peak of the crystallization region to a total intensity of all peaks is calculated after peak deconvolution is performed, which gives a crystallinity of the sample. A test process is represented by the following formula: Xe=Ic/(Ic+Ia), where the Xe is the crystallinity, the Ic is the intensity of the diffraction peak of the crystallization region, and the la is the intensity of the dispersion peak of the non-crystallization region.

In one example, a difference in crystallinity between the outer sealing side and the inner sealing side, calculated based on a volume fraction, ranges from 8% to 50%, preferably from 10% to 30%.

In the present disclosure, a minimum value within a difference range of the crystallinity refers to a difference measured from samples taken at positions, closest to the center line, in both the outer sealing region and the inner sealing region, and a maximum value refers to a difference measured from samples taken at positions, furthest from the center line, in both the outer sealing region and the inner sealing region, where a width of the samples is 1 mm, and a length of the samples is 20 mm.

In one example, a width of the sealing region ranges from 2 mm to 8 mm.

Exemplarily, the width of the sealing region is 2 mm, 3 mm, 4 mm, 5 mm, 6 mm, 7 mm, or 8 mm.

Preferably, the width of the sealing region ranges from 3 mm to 5 mm.

In one example, a material of the heat sealing layer is selected from polymer having a crystallinity of 30% to 80%, preferably polymer having a crystallinity of 40% to 60%.

In one example, the polymer is selected from at least one of polyolefin, halogenated polyolefin, and modified polyolefin.

Exemplarily, the polyolefin is selected from at least one of polypropylene, polyethylene, poly-1-butene, poly-4-methy-1-pentene, copolymer of ethylene-vinyl acetate, and copolymer of ethylene-acrylic acid.

Exemplarily, the halogenated polyolefin is selected from at least one of fluorinated polypropylene, chlorinated polypropylene, fluorinated polyethylene, fluorinated poly-1-butene, and copolymer of fluoroethylene-acrylic acid.

Exemplarily, the modified polyolefin may be one or more of physical modification and chemical modification, and the physical modification may specifically be one or more of filling modification, blending modification, and nucleating agent modification; and the chemical modification may be one or more of block modification and graft modification.

Preferably, the material of the heat sealing layer is polypropylene having a crystallinity of 30% to 80%.

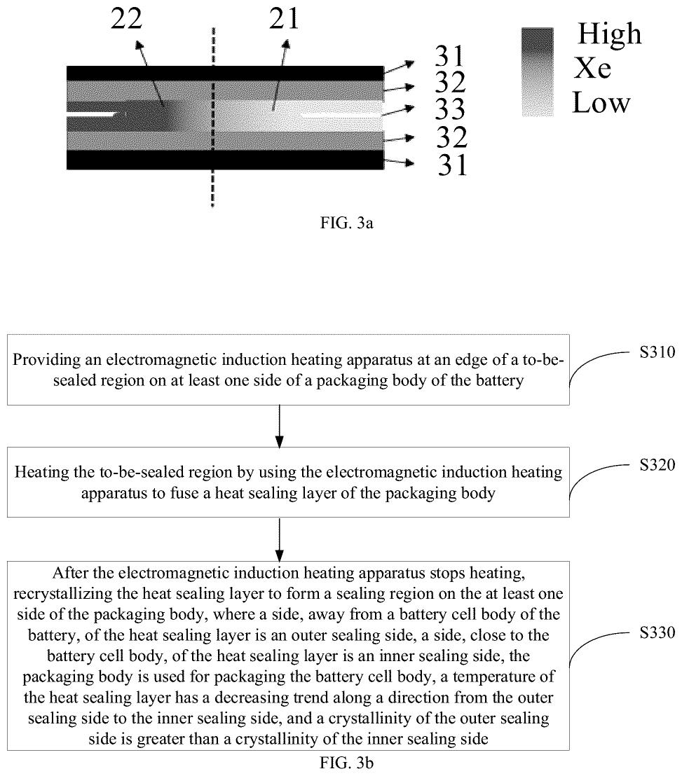

In one example, as shown in FIG. 3a, an aluminum laminated composite film is exemplified by nylon 31 (a protective layer), an aluminum layer 32 (a metal layer), and polypropylene 33 (a heat sealing layer) that are stacked in sequence, and the present disclosure further provides a method of obtaining a heat sealing layer having a sealing region, which includes the following steps:
firstly, cutting the aluminum laminated composite film containing a portion of the sealing region with scissors;
secondly, mixing hydrofluoric acid of 40% and warm water according to a ratio of 1:4, and then putting the aluminum laminated composite film into the prepared hydrofluoric acid, and allowing the aluminum layer to be immersed and left undisturbed in the hydrofluoric acid for a duration of 2 hours, so that the aluminum layer is completely dissolved in the hydrofluoric acid; and
thirdly, taking out a remaining film, rinsing off any excess hydrofluoric acid with clean water, and stripping a nylon layer to obtain a polypropylene film shown in FIG. 2, i.e., the heat sealing layer with the sealing region.

In one example, as shown in FIG. 2, the sealing region 2 of the polypropylene film (the heat sealing layer) is divided into the inner sealing region 21 and the outer sealing region 22 along a center line of its lengthwise direction.

In one example, FIG. 3a shows a cross section of the aluminum laminated composite film in a direction perpendicular to a plane where the battery cell body is located, and the battery cell body is actually located at a right side of the inner sealing region 21 shown in FIG. 3a. The sealing region is divided along a center line (for example, the dashed line shown in FIG. 3a) of its lengthwise direction, a region from the central line towards a side close to the battery cell is the inner sealing region 21, and a region from the center line towards a side away from the battery cell is the outer sealing region 22. Darkness of color represents a level of the crystallinity (Xe) (a darker color represents a high crystallinity (i.e., High shown in FIG. 3a), and a lighter color represents a low crystallinity (i.e., Low shown in FIG. 3a)), i.e., the crystallinity of the heat sealing layer has a decreasing trend along the direction from the outer sealing region to the inner sealing region.

In one example, the present disclosure further provides a method for preparing a battery to obtain the sealing region. As shown in FIG. 3b, the method for preparing the battery includes the following steps: S310: providing an electromagnetic induction heating apparatus at an edge of a to-be-sealed region on at least one side of a packaging body of the battery; S320: heating the to-be-sealed region by using the electromagnetic induction heating apparatus to fuse a heat sealing layer of the packaging body; and S330: after the electromagnetic induction heating apparatus stops heating, recrystallizing the heat sealing layer to form a sealing region on the at least one side of the packaging body, where a side, away from a battery cell body of the battery, of the heat sealing layer is an outer sealing side, a side, close to the battery cell body, of the heat sealing layer is an inner sealing side, the packaging body is used for packaging the battery cell body, a temperature of the heat sealing layer has a decreasing trend along a direction from the outer sealing side to the inner sealing side, and a crystallinity of the outer sealing side is greater than a crystallinity of the inner sealing side. The electromagnetic induction heating apparatus is applied to the edge of the to-be-sealed region; the to-be-sealed region is heated by using the electromagnetic induction heating apparatus to fuse the heat sealing layer; and after the electromagnetic induction heating apparatus stops heating, the heat sealing layer is recrystallized to form the sealing region. The temperature of the heat sealing layer has a decreasing trend along the direction from the outer sealing side to the inner sealing side, so that the crystallinity of the outer sealing side is greater than the crystallinity of the inner sealing side.

In a manufacturing process of a battery, after the battery cell is wrapped by an aluminum laminated composite film at an upper layer and an aluminum laminated composite film at a lower layer, the aluminum laminated composite film at an upper layer and the aluminum laminated composite film at a lower layer are tightly pressed using a pressure from a sealing head at an edge where the battery cell is in contact with the aluminum laminated composite films, so that the heat sealing layers (for example, polypropylene (PP)) in the aluminum laminated composite film at an upper layer and the aluminum laminated composite film at a lower layer are closely adhere to each other. After the above steps are completed, the electromagnetic induction heating apparatus (such as a high-frequency electromagnetic induction coil) is arranged on the edge of the to-be-sealed region, to heat the to-be-sealed region, and under an action of a high-frequency magnetic field, the metal layer (for example, the aluminum layer) in the aluminum laminated composite film generates an alternating current and generates heat close to the coil, so that the PP is fused, and the PP is recrystallized after heating is stopped, so as to form the sealing region. The outer sealing side of the sealing region is close to a heat source, and therefore, the temperature of the outer sealing side is relatively high, and the temperature of the sealing region has a decreasing trend along the direction from the outer sealing side to the inner sealing side. In other words, the temperature of the heat sealing layer has a decreasing trend along the direction from the outer sealing side to the inner sealing side, and the crystallinity of a material of the heat sealing layer decreases as the temperature decreases, and therefore, the crystallinity of the heat sealing layer has a decreasing trend along the direction from the outer sealing side to the inner sealing side.

In one example, a minimum distance between the electromagnetic induction heating apparatus and the edge of the to-be-sealed region ranges from 0.5 mm to 10 mm, preferably from 1 mm to 3 mm. The edge of the to-be-sealed region refers to an edge of a side, away from the battery cell, of the to-be-sealed region.

In one example, the electromagnetic induction heating apparatus is a high-frequency electromagnetic induction coil.

In one example, an excitation current of the electromagnetic induction coil ranges from 8 A to 20 A, and an alternating frequency of the electromagnetic induction coil ranges from 100 kHz to 600 KHz.

A principle of electromagnetic induction heating is that an alternating current generated by an induction heating power supply passes through an inductor (i.e., a coil) to create an alternating magnetic field, and a magnetic conductive object is placed in the alternating magnetic field to cut alternating magnetic lines, so that an alternating current (i.e., an eddy current) is generated inside the object, the eddy current causes free electrons within the object to move at a high speed in a directed manner, and the directional movement of the electrons is affected by a resistance of metal, thereby achieving an effect of heating the object.

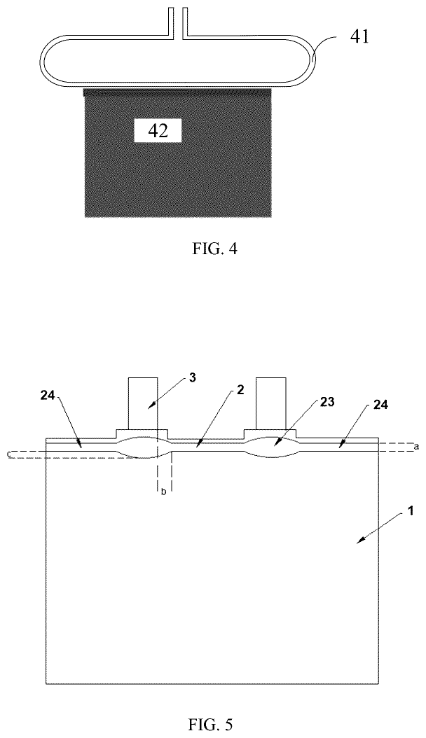

As shown in FIG. 4, in the electromagnetic induction heating, a coil 41 is close to a to-be-sealed region of an aluminum laminated composite film 42, so as to heat the to-be-sealed region.

In one example, as shown in FIG. 5, the battery cell body further includes a tab 3, the sealing region 2 includes a first sealing region 23 for sealing the tab 3 and a second sealing region 24 located on two sides of the first sealing region 23, and a width of a cross section of the first sealing region 23 is greater than a width of a cross section of the second sealing region 24.

Exemplarily, the battery cell body includes two tabs 3, and the two tabs 3 are a positive tab and a negative tab, respectively. Along an arrangement direction of the two tabs 3, the sealing region 2 is divided into the first sealing region 23 for sealing the tab 3 and the second sealing region 24 located on the two sides of the first sealing region 23. There are two first sealing regions 23 and three second sealing regions 24. At least a portion of the first sealing region 23 is adhered to the tab 3, so as to seal the tab 3. In some embodiments, along the arrangement direction of the two tabs 3, a size (a length) of the first sealing region 23 is not less than a size (a width) of the tab 3, and the arrangement direction of the two tabs 3 is perpendicular to a direction from the battery cell 1 to the tab 3, which is same as a length direction of the sealing region 2, and is also the same as a width direction of the tab 3. Along the direction from the battery cell 1 to the tab 3, a size (a width) of a cross section of the first sealing region 23 is greater than a size (a width) of a cross section of the second sealing region 24. The cross section refers to a cross section along a length direction or width direction of the battery cell 1 (a direction from a side of the tab 3 to another side, opposite to that side, of the tab 3).

In the battery cell of the present disclosure, the width of the first sealing region is increased on a basis of ensuring a length of the first sealing region, so that a sealing area at the tab is increased to enhance an adhesion strength and an adhesion area between the packaging body and the tab, thereby improving a packaging strength at the tab, so as to ensure that a packaging at the tab is tight and secure, and thus significantly reducing or completely avoiding a problem of virtual sealing, and effectively avoiding a risk that a sealing region at the tab is extremely prone to fracture when the battery cell undergoes gas generation, collision or dropping. Such an arrangement ensures that a packaging quality of a battery cell is improved, and potential risk factors leading to a failure of a battery cell due to inadequate sealing is solved, thereby more effectively ensuring a safe usage of a battery cell and ensuring an effective safety service life of a battery cell. Such an arrangement ensures that a battery cell with this packaging structure has stable performance and high safety.

In one example, as shown in FIG. 5, a cross section of the first sealing region 23 includes a central block, a first protruding block and a second protruding block along the direction from the battery cell 1 to the tab 3, the first protruding block is formed by protruding outwardly from a side of the central block, and the second protruding block is formed by protruding outwardly from another side of the central block.

The cross section of the second sealing region 24 is strip-shaped. In an embodiment, the cross section of the first sealing region 23 may be divided into the central block, the first protruding block and the second protruding block, a size (a width) of the central block is consistent with a size (a width) of the second sealing region 24 along the direction from the battery cell 1 to the tab 3, the first protruding block is located on a side, along a width direction of the central block, of the central block, the second protruding block is located on another side, along the width direction of the central block, of the central block, the first protruding block is formed by protruding outwardly from a side of the central block, the second protruding region is formed by protruding outwardly from another side of the central block, and the width direction of the central block is the direction from the battery cell 1 to the tab 3. Compared with the second sealing region 24, the first sealing region 23 has widened blocks that protrude in both a direction close to the tab 3 and a direction close to a bottom of the battery cell body.

The width of the cross section of the first sealing region 23 is greater than the width of the cross section of the second sealing region 24, and the first sealing region 23 is enlarged on both an upper side and a lower side along a width direction of the first sealing region 23, and an enlarged area is an effective sealing area for adhering to the tab 3, so that an adhesion area and an adhesion strength between the packaging body and the tab 3 can be significantly enhanced, so as to ensure a tight and secure packaging.

In one example, along a direction perpendicular to the direction from the battery cell 1 to the tab 3, i.e., along a length direction of the sealing region 2, an edge of a side of the first sealing region 23 exceeds beyond an edge of a same side of the tab 3 by a distance of 1 mm to 20 mm; and/or an edge of another side of the first sealing region 23 exceeds beyond an edge of a same side of the tab 3 by a distance of 1 mm to 20 mm.

It should be noted that the direction from the battery cell 1 to the tab 3 may be understood as an up-down direction parallel to a paper plane where the battery cell shown in FIG. 5 is located, and the direction perpendicular to the direction from the battery cell 1 to the tab 3 may be understood as a left-right direction parallel to the paper plane where the battery cell shown in FIG. 5 is located.

A second aspect of the present disclosure provides a method for preparing the battery according to the first aspect of the present disclosure, which includes the following steps.

An electromagnetic induction heating apparatus is provided on an edge of a to-be-sealed region of a packaging body, so that a temperature of a heat sealing layer has a decreasing trend along a direction from an outer sealing side to an inner sealing side, thereby making a crystallinity of the outer sealing side greater than a crystallinity of the inner sealing side.

A high-frequency magnetic field is applied to the edge of the to-be-sealed region, the magnetic field generates an alternating current and generates heat at an edge of an aluminum laminated film, and the heat diffuses from the edge towards an interior, so that the temperature of the heat sealing layer has a decreasing trend along the direction from the outer sealing side to the inner sealing side, thereby making the crystallinity of the outer sealing side greater than the crystallinity of the inner sealing side.

In one example, a minimum distance between the electromagnetic induction heating apparatus and the edge of the to-be-sealed region ranges from 0.5 mm to 3 mm, preferably from 1 mm to 3 mm.

In one example, the electromagnetic induction heating apparatus is a high-frequency electromagnetic induction coil.

In one example, an excitation current of the electromagnetic induction coil ranges from 8 A to 20 A, and an alternating frequency of the electromagnetic induction coil ranges from 100 kHz to 600 kHz.

The endpoints of any range and any value disclosed herein are not limited to this precise range or value, which should be understood to include values that are close to these ranges or values. As for a numerical range, the endpoint values of various ranges, the endpoint values and the individual point values of various ranges, and the individual point values may be combined with each other, so as to obtain one or more new numerical ranges, which should be considered as specifically disclosed herein.

The technical solutions in the embodiments of the present disclosure may be clearly and completely described below with reference to the embodiments of the present disclosure. All other embodiments obtained by a person of ordinary skill in the art based on the embodiments of the present disclosure without creative efforts shall fall within the protection scope of the present disclosure. The present disclosure may be described in detail below with reference to the specific embodiments, and these embodiments are used for understanding and not limiting the present disclosure. Materials, reagents, and the like used in the following embodiments may be obtained from a commercial path unless otherwise specified.

### Embodiment 1

A battery cell (which has a conventional structure, such as a pouch battery cell, including a positive electrode plate, a separator, a negative electrode plate, and an electrolyte) and an aluminum laminated composite film for wrapping the battery cell are prepared. The aluminum laminated composite film includes nylon (i.e., a protective layer), an aluminum layer (i.e., a metal layer), and a polypropylene (for example, PP with a crystallinity of 50%) layer (i.e., a heat sealing layer) that are stacked in sequence. A to-be-sealed region with a width of 3 mm is planned on an edge of three to-be-closed sides of the aluminum laminated composite film, a high-pressure sealing head and an electromagnetic induction coil are used to apply heat and pressure to the to-be-sealed region, so as to form a sealing region, and the battery cell is sealed and wrapped in the sealing region, as shown in FIG. 1.

A processing is performed on the sealing region, which includes the following contents.

The to-be-sealed region of the aluminum laminated film at an upper layer and the to-be-sealed region of the aluminum laminated film at a lower layer are tightly pressed using a pressure from the sealing head, so that the PP layer of the aluminum laminated film at an upper layer and the PP layer of the aluminum laminated film at a lower layer are closely adhered to each other. After the above steps are completed, a high-frequency magnetic field is applied at a position that is 1 mm away from an edge of the to-be-sealed region, an excitation current of an induction coil is 12 A, an alternating frequency is 200 kHz, and under an action of the high-frequency magnetic field, the aluminum layer in the aluminum laminated film generates an alternating current and generates heat close to the coil, so that the PP is fused, and the PP is recrystallized after heating is stopped, so as to form the sealing region. An outer sealing side of the sealing region is close to a heat source, and therefore, a temperature of the outer sealing side is relatively high, and a temperature of the sealing region has a decreasing trend along the direction from the outer sealing side to an inner sealing side. In other words, the temperature of the heat sealing layer has a decreasing trend along the direction from the outer sealing side to the inner sealing side, and the crystallinity of a material of the heat sealing layer decreases as the temperature decreases, and therefore, the crystallinity of the heat sealing layer has a decreasing trend along the direction from the outer sealing side to the inner sealing side, thereby making the crystallinity of the outer sealing side greater than the crystallinity of the inner sealing side.

Samples were taken for a crystallinity test at positions that are 1 mm away from edges of the outer sealing side and the inner sealing side (i.e., a side away from a center line), a width of the samples is 1 mm, a length of the samples is 20 mm, the samples are subjected to the crystallinity test by DSC, and a test process is expressed by the following formula: Xe=ΔH_{actual}/ΔH_{(crystallinity of 100°%)}. A melting enthalpy of the PP (polypropylene) at the crystallinity of 100% is calculated as 165 J/g, and a difference in crystallinity between the outer sealing side and the inner sealing side is measured to be 1%.

### Embodiment 2

The battery cell and the aluminum laminated composite film that are the same as those of the embodiment 1 are used, and a width of the sealing region is 3 mm.

A processing is performed on the sealing region, which includes the following contents.

The to-be-sealed region of the aluminum laminated film at an upper layer and the to-be-sealed region of the aluminum laminated film at a lower layer are tightly pressed using a pressure from the sealing head, so that the PP layer of the aluminum laminated film at an upper layer and the PP layer of the aluminum laminated film at a lower layer are closely adhered to each other. After the above steps are completed, a high-frequency magnetic field is applied at a position that is 2 mm away from an edge of the to-be-sealed region, an excitation current of an induction coil is 10 A, an alternating frequency is 300 kHz, and under an action of the high-frequency magnetic field, the aluminum layer in the aluminum laminated film generates an alternating current and generates heat close to the coil, so that the PP is fused, and the PP is recrystallized after heating is stopped, so as to form the sealing region, thereby making the crystallinity of the outer sealing side greater than the crystallinity of the inner sealing side.

Samples were taken for a crystallinity test at positions that are 1 mm away from edges of the outer sealing side and the inner sealing side, a width of the samples is 1 mm, a length of the samples is 20 mm, the samples are subjected to the crystallinity test by XRD, and a test process is expressed by the following formula: Xe=Ic/(Ic+Ia). A difference in crystallinity between the outer sealing side and the inner sealing side is measured to be 10%.

### Embodiment 3

The battery cell and the aluminum laminated composite film that are the same as those of the embodiment 1 are used, and a width of the sealing region is 2 mm.

A processing is performed on the sealing region, which differs from the embodiment 1 in that a high-frequency magnetic field is applied at a position that is 2 mm away from an edge of the to-be-sealed region; and finally, a difference in crystallinity between the outer sealing side and the inner sealing side is measured to be 0.8%.

### Embodiment 4

The battery cell and the aluminum laminated composite film that are the same as those of the embodiment 1 are used, and a width of the sealing region is 7 mm.

A processing is performed on the sealing region, which differs from the embodiment 1 in that a high-frequency magnetic field is applied at a position that is 0.8 mm away from an edge of the to-be-sealed region; and finally, a difference in crystallinity between the outer sealing side and the inner sealing side is measured to be 5%.

### Embodiment 5

The battery cell and the aluminum laminated composite film that are the same as those of the embodiment 2 are used, and a width of the sealing region is 2 mm.

A processing is performed on the sealing region, which differs from the embodiment 1 in that a high-frequency magnetic field is applied at a position that is 2 mm away from an edge of the to-be-sealed region; and finally, a difference in crystallinity between the outer sealing side and the inner sealing side is measured to be 8%.

### Embodiment 6

The battery cell and the aluminum laminated composite film that are the same as those of the embodiment 2 are used, and a width of the sealing region is 7 mm.

A processing is performed on the sealing region, which differs from the embodiment 1 in that a high-frequency magnetic field is applied at a position that is 0.8 mm away from an edge of the to-be-sealed region; and finally, a difference in crystallinity between the outer sealing side and the inner sealing side is measured to be 20%.

### Comparative Example 1

The comparative example 1 is performed with reference to the embodiment 1, with the exception that heat pressing using an electromagnetic induction coil is not employed. A difference in crystallinity between the outer sealing side and the inner sealing side measured by DSC is less than 0.3%.

### Comparative Example 2

The comparative example 1 is performed with reference to the embodiment 1, with the exception that heat pressing using an electromagnetic induction coil is not employed. A difference in crystallinity between the outer sealing side and the inner sealing side measured by XRD is less than 8%.

### Test Example

Firstly, a safety performance test is conducted on a battery.

An inflation and bursting experiment is performed. Specifically, a circular hole with a diameter of about 1 mm is drilled on a surface of an aluminum laminated film of a pouch battery by using a blade after the packaging is completed, and after the circular hole is tightly sealed by an inflation nozzle, a packaging of the aluminum laminated film of the battery is inflated. An air pressure is firstly inflated to 0.2 MPa, the air pressure of 0.01 MPa is increased each time after the air pressure is stable, and the air pressure is continuously increased after the air pressure is stable until the packaging of the aluminum laminated film explodes or cracks along a sealing region, at which point the pressure is lost, and a maximum air pressure before a failure of the packaging is recorded. The results are recorded in Table 1.

TABLE 1

| | Air pressure at the | |
|---|---|---|
| | time of bursting | |
| Embodiment 1 | 0.68 | MPa |
| Embodiment 2 | 0.65 | MPa |
| Embodiment 3 | 0.62 | MPa |
| Embodiment 4 | 0.74 | MPa |
| Embodiment 5 | 0.51 | MPa |
| Embodiment 6 | 0.75 | MPa |
| Comparative Example 1 | 0.29 | MPa |
| Comparative Example 2 | 0.35 | MPa |

Secondly, a service life test is conducted on a battery.

The battery is stored in an environment with a high temperature and a high humidity.

Firstly, a thickness, a voltage and an internal resistance of the battery in its as-received state are measured at a temperature of 25° C.±5° C.

Secondly, the battery is discharged to 3 V at 0.2 C, and then the battery stands for 10 min; the battery is charged to its upper limit voltage (a cut-off current 0.05 C) at a constant current constant voltage of 0.7 C, and then the battery stands for 10 min; and the battery is discharged to 3 V (an initial capacity) at 0.2 C.

Thirdly, after the battery is fully charged, the battery stands for 10 min, and then the battery is charged to its upper limit voltage (a cut-off current 0.05 C) at the constant current constant voltage of 0.7 C.

Fourthly, after the battery stands for 2 h, the voltage, the internal resistance and the thickness of the battery in a fully charged state are measured.

Fifthly, the battery is stored in an environment with a temperature of 60±2° C. for 14 days without testing process data.

Sixthly, after the storage period, the battery is removed, and after the battery has returned to a room temperature, the final voltage, the final internal resistance, and the final thickness of the battery are measured.

Seventhly, the battery is discharged to a cut-off voltage of 3.0 V (a residual capacity) at 0.2 C.

Eighthly, the battery stands for 10 min.

Ninthly, the battery is charged to its upper limit voltage (a cut-off current 0.05 C) at the constant current constant voltage of 0.7 C, the battery stands for 10 min, and then the battery is discharged to 3 V (a recovery capacity) at 0.2 C.

Tenthly, results of a capacity retention rate (a residual capacity/an initial capacity), a capacity recovery rate (a recovery capacity/an initial capacity), and a thickness change rate are recorded, as shown in Table 2.

TABLE 2

| | Thickness | Capacity retention | Capacity recovery |
|---|---|---|---|
| | change rate | rate of battery | rate of battery |
| Embodiment 1 | 1.52% | 91.7% | 95.4% |
| Embodiment 2 | 1.87% | 91.8% | 95.3% |
| Embodiment 3 | 1.83% | 91.1% | 95.2% |
| Embodiment 4 | 1.41% | 92.2% | 96.0% |
| Embodiment 5 | 1.92% | 90.0% | 94.9% |
| Embodiment 6 | 1.65% | 92.0% | 96.2% |
| Comparative | 3.42% | 87.6% | 93.5% |
| Example 1 | | | |
| Comparative | 2.82% | 88.2% | 93.9% |
| Example 2 | | | |

Thirdly, a water vapor barrier test is conducted on a battery.

A water bath test is performed. After a battery cell is charged to full power (a cut-off current 0.025 C) at 0.7 C, the battery is placed in a water bath at a temperature of 60° C. for 90 days, a thickness of the battery is tested every day by using a battery thickness gauge based on a panel pressure gap (PPG), and when a thickness change rate of the battery is greater than 20%, it is recorded as NG, and a number of days required for the battery to reach the NG is statistically analyzed. The results are recorded in Table 3.

TABLE 3

| | Water bath failure |
|---|---|
| | time/day |
| Embodiment 1 | 47 |
| Embodiment 2 | 44 |
| Embodiment 3 | 50 |
| Embodiment 4 | 45 |
| Embodiment 5 | 49 |
| Embodiment 6 | 42 |
| Comparative Example 1 | 32 |
| Comparative Example 2 | 35 |

It can be seen from the above data in Table 1 to Table 3 that, the battery of the present disclosure contains the aluminum laminated composite film with a high packaging strength and a strong resistance to bending, which may more effectively block water vapor from entering a battery, and also improves safety performance and a service life of a battery.

The above are only preferred embodiments of the present disclosure and are not intended to limit the present disclosure, and any modification, equivalent replacement, etc. made within the spirit and the principles of the present disclosure should be included in the protection scope of the present disclosure.

What is claimed is:

1. A battery, comprising a battery cell body and a packaging body configured to package the battery cell body, wherein
an edge of at least one side of the packaging body is provided with a sealing region to seal and wrap the battery cell body in the packaging body, and the packaging body comprises a heat sealing layer; and
in the sealing region, a side, away from the battery cell body, of the heat sealing layer is an outer sealing side, a side, close to the battery cell body, of the heat sealing layer is an inner sealing side, and a crystallinity of the outer sealing side is greater than a crystallinity of the inner sealing side.

2. The battery according to claim 1, wherein a crystallinity of the heat sealing layer has a decreasing trend along a direction from the outer sealing side to the inner sealing side.

3. The battery according to claim 1, wherein a difference in crystallinity between the outer sealing side and the inner sealing side, calculated based on a mass fraction, ranges from 0.5% to 50%.

4. The battery according to claim 1, wherein a difference in crystallinity between the outer sealing side and the inner sealing side, calculated based on a volume fraction, ranges from 8% to 50%.

5. The battery according to claim 1, wherein along a direction from the inner sealing side to the outer sealing side, a size of the sealing region ranges from 2 mm to 8 mm.

6. The battery according to claim 1, wherein along a direction from the inner sealing side to the outer sealing side, a size of the sealing region ranges from 3 mm to 5 mm.

7. The battery according to claim 1, wherein a material of the heat sealing layer is selected from polymer having a crystallinity of 30% to 80%.

8. The battery according to claim 1, wherein a material of the heat sealing layer is selected from polymer, and the polymer is selected from at least one of polyolefin, halogenated polyolefin, and modified polyolefin.

9. The battery according to claim 1, wherein the battery cell body comprises a tab, the sealing region at a side where the tab is located comprises a first sealing region for sealing the tab and a second sealing region located on two sides of the first sealing region, and along a direction from the battery cell body to the tab, a size of a cross section of the first sealing region is greater than a size of a cross section of the second sealing region.

10. The battery according to claim 9, wherein the cross section of the first sealing region comprises a central block, a first protruding block and a second protruding block along the direction from the battery cell body to the tab, the first protruding block is formed by protruding outwardly from a side of the central block, and the second protruding block is formed by protruding outwardly from another side of the central block.

11. The battery according to claim 10, wherein along the direction from the battery cell body to the tab, a size of the central block is equal to a size of the second sealing region.

12. The battery according to claim 9, wherein along a direction perpendicular to the direction from the battery cell body to the tab, an edge of a side of the first sealing region exceeds beyond an edge of a same side of the tab by a distance of 1 mm to 20 mm.

13. The battery according to claim 9, wherein along a direction perpendicular to the direction from the battery cell body to the tab, an edge of another side of the first sealing region exceeds beyond an edge of a same side of the tab by a distance of 1 mm to 20 mm.

14. The battery according to claim 9, wherein along a direction perpendicular to the direction from the battery cell body to the tab, a size of the first sealing region is greater than or equal to a size of the tab.

15. A method for preparing a battery, comprising:
S310: providing an electromagnetic induction heating apparatus at an edge of a to-be-sealed region on at least one side of a packaging body of the battery;
S320: heating the to-be-sealed region by using the electromagnetic induction heating apparatus to fuse a heat sealing layer of the packaging body; and
S330: after the electromagnetic induction heating apparatus stops heating, recrystallizing the heat sealing layer to form a sealing region on the at least one side of the packaging body, wherein a side, away from a battery cell body of the battery, of the heat sealing layer is an outer sealing side, a side, close to the battery cell body, of the heat sealing layer is an inner sealing side, the packaging body is used for packaging the battery cell body, a temperature of the heat sealing layer has a decreasing trend along a direction from the outer sealing side to the inner sealing side, and a crystallinity of the outer sealing side is greater than a crystallinity of the inner sealing side.

16. The method for preparing the battery according to claim 15, wherein a minimum distance between the electromagnetic induction heating apparatus and the edge of the to-be-sealed region ranges from 0.5 mm to 10 mm.
